(19) United States
(12) Patent Application Publication
(10) Pub. No.: US 2019/0101993 A1
(43) Pub. Date: Apr. 4, 2019

(54) APPARATUS, SYSTEM AND METHOD FOR MAGNETIC FIELD SENSING

(71) Applicant: Interdigital CE Patent Holdings, Paris (FR)

(72) Inventor: KENT LYONS, Mountain View, CA (US)

(21) Appl. No.: 16/146,393

(22) Filed: Sep. 28, 2018

Related U.S. Application Data
(60) Provisional application No. 62/565,136, filed on Sep. 29, 2017.

(51) Int. Cl. G06F 3/0346; G06F 3/01; G06F 3/038

(52) U.S. Cl. CPC G06F 3/0346; G06F 2203/0331; G06F 3/038; G06F 3/017

(57) ABSTRACT

System, apparatus and method for magnetic field tracking to determine a parameter of a user input, e.g., a position or an orientation of an object, using signals from multiple magnetic field sensors mounted on the object including correcting the sensor signals for ambient magnetic field effects.

### TECHNICAL FIELD

The present disclosure generally involves magnetic field sensing.

### BACKGROUND

This section is intended to introduce a reader to various aspects of art, which may be related to various aspects of the present principles that are described and/or claimed below. This discussion is believed to be helpful in providing the reader with background information to facilitate a better understanding. Accordingly, it should be understood that these statements are to be read in this light, and not as admissions of prior art.

For many categories of wearable computing, user input is still an open problem. Wearables with head mounted displays create a virtual image for the user. Therefore, they have no surface that can be used for input like more conventional mobile devices which rely heavily on capacitive touch. A wearable input system such as one worn on a hand of a user can provide continuous input and offer multiple degrees of freedom (DOF), e.g., two or three DOF, so that it can be used as an arbitrary pointer. One such system would be a wearable input system in a glove configuration. However, a wearable device, particularly when worn on a user's hand, should place minimal burden on the user's hand. That is, any such device should not interfere when the user wishes to interact with the real world. For example, the user should be able to touch and position their hand wherever they choose to provide input. A wearable system involving a user's hand should not suffer from occlusion.

### SUMMARY

These and other drawbacks and disadvantages of the prior art are addressed by the present principles, which are directed to apparatus, methods and systems for magnetic field sensing.

In accordance with an aspect of the present principles, a method of determining a position and an orientation of an object having a plurality of degrees of freedom of motion, comprises receiving a plurality of signals from each of a respective one of a plurality of magnetic field sensors in an array of sensors located in proximity to a magnet mounted on the object, wherein each sensor in the array has a fixed position with respect to other sensors in the array and each of the plurality of signals represents a magnetic field value at the respective sensor, processing the plurality of signals to correct for an ambient magnetic field component and for non-ideal characteristics of the sensors, creating a motion model of the object using a kinematic model of a motion of the object, and processing the corrected signals using a particle filter and the motion model to determine the position and orientation of the object.

In accordance with another aspect, an embodiment of a method comprises receiving a plurality of signals from each of a respective one of a plurality of magnetic field sensors in an array of sensors located in proximity to a magnet mounted on an object, wherein each sensor in the array has a fixed position with respect to other sensors in the array and each of the plurality of signals represents a magnetic field value at the respective sensor; processing the plurality of signals to provide a plurality of respective corrected signals including a correction for an ambient magnetic field component and for non-ideal characteristics of the sensors; and processing the plurality of corrected signals to determine a parameter associated with an input from a user. In accordance with another aspect, the processing of the plurality of signals comprises using pairs of signals included in the plurality of signals from the plurality of sensors to determine two difference readings to cancel out the ambient magnetic field in the plurality of corrected signals. In accordance with another aspect, the processing of the plurality of corrected signals comprises creating a motion model of the object using a kinematic model of a motion of the object.

In accordance with another aspect, the processing of the plurality of corrected signals comprises using a particle filter and a motion model to determine the parameter. In accordance with another aspect, an embodiment of a method further comprises calibrating the plurality of sensors prior to processing the plurality of signals. In accordance with another aspect, calibrating comprises determining a minimum volume enclosing ellipsoid (MVEE) for each sensor.

In accordance with another aspect, calibrating further comprises determining a transform for each sensor to transform the ellipsoid associated with the MVEE for the sensor to a sphere.

In accordance with another aspect, calibrating further comprises scaling the sphere associated with each sensor. In accordance with another aspect, calibrating further comprises processing the data associated with the scaled sphere for each sensor to determine a magnetic moment.

In accordance with another aspect of the present principles, an embodiment of apparatus comprises at least one processor configured to: receive a plurality of signals from each of a respective one of a plurality of magnetic field sensors in an array of sensors located in proximity to a magnet mounted on an object wherein each sensor in the array has a fixed position with respect to other sensors in the array and each of the plurality of signals represents a magnetic field value at the respective sensor; process the plurality of signals to provide a plurality of respective corrected signals including a correction for an ambient magnetic field component and for non-ideal characteristics of the sensors; and process the plurality of corrected signals to determine a parameter associated with an input from a user. In accordance with another aspect, a processor is further configured to process the plurality of signals using pairs of signals included in the plurality of signals from the plurality of sensors to determine two difference readings to cancel out the ambient magnetic field in the plurality of corrected signals. In accordance with another aspect, a processor is further configured to process the plurality of corrected signals to create a motion model of the object using a kinematic model of a motion of the object. In accordance with another aspect, a processor is further configured to process the plurality of corrected signals using a particle filter and a motion model to determine the parameter. In accordance with another aspect, a processor is further configured to calibrate the plurality of sensors prior to processing the plurality of signals. In accordance with another aspect, calibrating by a processor comprises the processor determining a minimum volume enclosing ellipsoid (MVEE) for each sensor. In accordance with another aspect, calibrating by a processor further comprises determining a transform for each sensor to transform the ellipsoid associated with the MVEE for the sensor to a sphere. In accordance with another aspect, calibrating by a processor further comprises scaling the sphere associated with each sensor. In accordance with another aspect, calibrating by a processor further comprises processing the data associated with the scaled sphere for each sensor to determine a magnetic moment.

In accordance with another aspect of the present principles, an embodiment of an apparatus or method may include an object comprising a hand of a user having a plurality of degrees of freedom of motion and a parameter comprising at least one of a position of the hand and an orientation of the hand.

In accordance with another aspect of the present principles, an embodiment of a system comprises: a magnet configured for mounting on an object; a plurality of magnetic field sensors forming an array of sensors located in proximity to the magnet, wherein each sensor in the array has a fixed position with respect to other sensors in the array and each sensor produces a signal representing a magnetic field value at the sensor; and a processor processing the plurality of signals produced by the array of sensors to provide a respective plurality of corrected signals including a correction for an ambient magnetic field component and for a non-ideal characteristic of the sensors, and processing the plurality of corrected signals to determine a parameter associated with an input from a user. In accordance with another aspect, processing of the plurality of signals by the processor comprises using pairs of signals included in the plurality of signals from the plurality of sensors to determine two difference readings to cancel out the ambient magnetic field in the plurality of corrected signals. In accordance with another aspect, processing of the plurality of collected signals by the processor comprises creating a motion model of the object using a kinematic model of a motion of the object. In accordance with another aspect, processing the plurality of corrected signals by the processor comprises using a particle filter and a motion model to determine the parameter. In accordance with another aspect, In accordance with another aspect, the processor may calibrate the plurality of sensors prior to processing the plurality of signals. In accordance with another aspect, calibrating by the processor may comprise the processor determining a minimum volume enclosing ellipsoid (MVEE) for each sensor. In accordance with another aspect, calibrating by the processor may further comprise determining a transform for each sensor to transform the ellipsoid associated with the MVEE for the sensor to a sphere. In accordance with another aspect, calibrating by the processor may further comprise scaling the sphere associated with each sensor. In accordance with another aspect, calibrating by the processor may further comprise processing the data associated with the scaled sphere for each sensor to determine a magnetic moment.

In accordance with another aspect, an embodiment of an apparatus or a method or a system may involve an object comprising a hand of a user having a plurality of degrees of freedom of motion and the parameter comprising at least one of a position of the hand and an orientation of the hand.

In accordance with another aspect, a non-transitory computer-readable medium storing computer-executable instructions executable to perform one or more aspects of an embodiment or embodiments of methods in accordance with the present disclosure.

### BRIEF DESCRIPTION OF THE DRAWING

These, and other aspects, features and advantages of the present disclosure will be described or become apparent from the following detailed description which is to be read in connection with the accompanying drawings wherein like numbered elements represent the same or similar features and wherein:

FIG. 1 illustrates an application of an aspect of the present principles;

FIG. 2 illustrates in the form of a graph, exemplary data depicting an aspect of the present principles;

FIG. 3 illustrates in block diagram form an exemplary embodiment in accordance with the present disclosure;

FIG. 4 illustrates in flowchart form au exemplary embodiment of a method in accordance with an aspect of the present principles; and

FIG. 5 illustrates in flowchart form an exemplary embodiment of a method in accordance with an aspect of the present principles.

It should be understood that the drawing(s) are for purposes of illustrating the concepts of the disclosure and is not necessarily the only possible configuration for illustrating the disclosure.

### DETAILED DESCRIPTION

The present description illustrates the principles of the present disclosure. It will thus be appreciated that those skilled in the art will be able to devise various arrangements that, although not explicitly described or shown herein, embody the principles of the disclosure and are included within its scope. Further, other embodiments beyond those described are contemplated and intended to be encompassed within the scope of the present disclosure. For example, additional embodiments may be created by combining, deleting, modifying, or supplementing various features of the disclosed embodiments.

In an exemplary embodiment of magnetic field sensing in accordance with the present disclosure, a system senses a magnetic field produced, for example, by a permanent magnet worn on a user's hand, e.g., a fingertip. The magnetic field may be sensed, for example, using one or more magnetic field sensors such as magnetometers that are positioned on a user's hand, e.g., on the back of the user's hand. In an exemplary embodiment, four magnetometers are used as explained herein. The system includes a processor that receives a plurality of signals from respective ones of the magnetometers providing data regarding the magnetic field and processes that data to determine one or more parameters associated with the user input, e.g., one or more of position and orientation of the hand or fingertip as indicated by the position and orientation of the magnet with respect to the sensors.

This approach has at least several benefits. The magnet is a passive component and, therefore, there is no need to place a battery on the fingertip or run power to it remotely down the fingers in some way. It requires no power to generate a magnetic field. All active components that may be placed on a user (magnetometers and processor, e.g., microcontroller) may be placed or positioned in a location convenient for a user such as farther back on the hand. In another embodiment, certain components such as the processor may be placed remotely from the user and receive the data to be processed by wireless communications. This approach also leaves most of the hand unencumbered. The magnet can be worn on the back of the finger, e.g., affixed to an artificial finger nail. Also, the pads of the fingertips are left open to touch and interact with the world, there are no wires running down the hand, and nothing to be held. The magnetic field also travels through the body unencumbered and therefore does not suffer from occlusion. FIG. 1 shows an exemplary embodiment of a system in accordance with the present principles and positioned on a model of a hand.

In accordance with an aspect of the present disclosure, an embodiment includes a processor processing the data utilizing probabilistic methods for determining the location of the magnet and, therefore, the fingertip including the impact of the ambient magnetic field on the system and utilizing additional information to further constrain the solution space.

A magnetic field generated by a dipole maple can be described as follows:

$$B = K ( \frac{3 r ( m \cdot r )}{{\vert r \vert}^{5}} - \frac{m}{{\vert r \vert}^{3}} ) , K = \frac{M}{4 π} \qquad ( 1 )$$

where B is a vector composed of the three orthogonal magnetic field components:

B=[Bx,By,Bz]^{T} (2)

and M is the magnetic moment for the magnetic we are considering.

If the magnet is placed at the point (a, b, c) and we consider the magnetic field at point (x, y, z) then:

P=[x,y,z]^{T}, Q=[a,b,c]^{T}, r=P−Q (3)

Finally, we need the orientation of be magnet, m is a unit vector representing this orientation:

m=[m,n,o]^{T}, |m|= (4)

Also note that this vector only has two degrees of freedom (since the magnet is symmetric about it's pole) and can be turned into an angular representation such as:

β=arctan 2(\sqrt{mⁿ+n²},o)

γ=arctan 2(n,m) (5)

A magnetometer provides a 3-axis measurement of the magnetic field:

H=[Hx,Hy,Hz]^{T} (6)

and if the sensor is a at position P with orientation m, then the sensor reading H corresponds to magnetic field B at that point:

H=B (7)

In using a magnetic field to determine a position, it is necessary to solve the inverse of this non-linear system of equations (Equation 1). In particular, for a given sensor reading (H) it is necessary to determine the position P and orientation m. In this form, the equation is under-constrained because there are three sensor values and five unknowns (three degrees of freedom for position and two for orientation).

In accordance with an aspect of the present disclosure, an exemplary embodiment solves at least three different problems: 1) determine parameters such as the position and orientation of a magnet relative to a set of magnetometers. 2) account for the ambient magnetic field, and 3) overcome challenges related to the non-linear nature of the resulting set of equations while also providing for a solution that can deal with real sensor data which might have noise and might not be perfectly calibrated or aligned.

In accordance with another aspect of the present disclosure, an exemplary embodiment provides a direct approach for using Equation 1 to determine parameters such as position and orientation. As shown above, a system including only one sensor is under constrained. An exemplary embodiment in accordance with the present principles includes adding a second sensor that creates an over-constrain on the system of equations.

In an exemplary embodiment, two sensors are physically attached to each other with a known, fixed offset between them. For example, a first sensor (s=0) is kept at the origin (P1=0) and a second sensor (s=1) is added at a second location, e.g.: P₁=[2 cm,0 cm,0 cm]^{T}. Having the sensors affixed to each other causes m to be the same for both sensors. Therefore, we have the following system of equations:

$${B}_{0} = K ( \frac{3 {r}_{0} ( m \cdot {r}_{0} )}{{\vert {r}_{0} \vert}^{5}} - \frac{m}{{\vert {r}_{0} \vert}^{3}} ) , {r}_{0} = {P}_{0} - Q = - Q \\ {B}_{1} = K ( \frac{3 {r}_{1} ( m \cdot {r}_{1} )}{{\vert {r}_{1} \vert}^{5}} - \frac{m}{{\vert {r}_{1} \vert}^{3}} ) , {r}_{1} = {P}_{1} - Q \qquad ( 8 )$$

This system of non-linear equations can be solved to find Q and m such that H₀=B₀ and H₁=B₁. This provides the position in 3D and provides the two degrees of freedom for the orientation of the magnet.

To account for the ambient magnetic field, an exemplary embodiment assumes the ambient magnetic field Hₐ is locally uniform. This is a safe assumption for the geomagnetic field since the field source is very far away and the magnetic field falls off approximately at the power of 3 with distance Let the field measured by sensor 1 and sensor be H₁′ and H₂′, respectively. Therefore, the reading is a combination of the field generated by the magnet and the ambient field Hₐ:

H′₁=H₁+Hₐ

H′₂=H₂+Hₐ (9)

To obtain a magnetic field reading without the ambient component, the processor processes the data to take a difference:

$$\begin{matrix}Δ H = {H}_{2}^{′} - {H}_{1}^{′} \\ = ( {H}_{2} + {H}_{a} ) - ( {H}_{1} + {H}_{a} ) \\ = {H}_{2} - {H}_{1}\end{matrix} \qquad ( 10 )$$

This approach removes the influence of the ambient field. However, the absolute magnetic field values needed for Equation 8 are unknown.

To find both the position and orientation of the magnet while also accounting for the ambient magnetic field, in accordance with an aspect of the present principles an exemplary embodiment combines the approaches used in Equations 8 and 10. In doing so, an exemplary embodiments adds a third sensor (s=2) at a third location; e.g.: P₂=[0 cm,2 cm,0 cm]^{T}; and have a third magnetic field equation:

$${B}_{2} = K ( \frac{3 {r}_{2} ( m \cdot {r}_{2} )}{{\vert {r}_{2} \vert}^{5}} - \frac{m}{{\vert {r}_{2} \vert}^{3}} ) , {r}_{2} = {P}_{2} - Q \qquad ( 11 )$$

Then, pairs of sensors are used to determine two difference readings to cancel out the ambient magnetic field:

ΔB₂₀=B₂−B₀, ΔH₂₀=H₂−H₀

ΔB₂₁=B₁−B₁, ΔH₂₁=H₂−H₁ (12)

Finally, the system of equations can be solved such that:

ΔB₂₀=ΔH₂₀, ΔB₂₁=ΔH₂₁ (13)

Or combining Equations 8, 11, and 12, Q and in are found such that the following holds:

$$K ( \frac{3 ( {P}_{2} - Q ) ( m \cdot ( {P}_{2} - Q ) )}{{\vert {P}_{2} - Q \vert}^{5}} - \frac{m}{{\vert {P}_{2} - Q \vert}^{3}} - \frac{3 ( {P}_{0} - Q ) ( m \cdot ( {P}_{0} - Q ) )}{{\vert {P}_{0} - Q \vert}^{5}} + \frac{m}{{\vert {P}_{0} - Q \vert}^{3}} ) = {H}_{2} - {H}_{0} \\ K ( \frac{3 ( {P}_{2} - Q ) ( m \cdot ( {P}_{2} - Q ) )}{{\vert {P}_{2} - Q \vert}^{5}} - \frac{m}{{\vert {P}_{2} - Q \vert}^{3}} - \frac{3 ( {P}_{1} - Q ) ( m \cdot ( {P}_{1} - Q ) )}{{\vert {P}_{1} - Q \vert}^{5}} + \frac{m}{{\vert {P}_{1} - Q \vert}^{3}} ) = {H}_{2} - {H}_{1} \qquad ( 14 )$$

Numerical approaches to solving the non-linear system of equations may produce poor results due to various factors. For example, the complexity of the equation may be less conducive to optimization approaches. In addition, Equation 14 is theoretical, but the data being used comprises readings produced by a sensing system. That is, actual sensors such as those used in an exemplary embodiment in accordance with the present principles may produce readings including noise; the sensors may not be perfectly calibrated; there may be slight misalignments.

Such factors are addressed by processing in accordance with an aspect of the present disclosure wherein an exemplary embodiment incorporates processing including a particle filter. A particle filter provides a probabilistic approach that effectively handles issues such as sensor noise. Each particle i represents the position Qᵢ and orientation mᵢ of the magnet. In accordance with an aspect of the present disclosure, an exemplary embodiment includes a likelihood function to determine the probability of a given state being supported by a given measurement. The likelihood function is based on the difference between the estimate of the magnetic field derived from the current state and the actual measurements. In particular, a particle state is used to solve Equation 14 and obtain associated estimates of ΔBᵢ₂₀ and ΔBᵢ₂₁. This is in contrast to approaches which need to solve the inverse of Equation 14 by starting with magnetic field readings and attempting to solve for Qᵢ and mᵢ. Then, the difference between the estimated magnetic field values and the measured sensor values (ΔH₂₀ and ΔH₂₁) is calculated. This difference or error (ϵ) is transformed into a metric of particle error using the formula: pᵢ=c/(c+ϵ²) where c is a constant dictating the shape of the distribution. An exemplary embodiment uses the value c=1.0. This metric is then used to resample the particles for the next iteration. States with low difference between the estimated magnetic field and the measured magnetic field are more likely to be selected for the next round and vice versa.

In accordance with another aspect of the present disclosure, each particle does not directly represent the position (Qᵢ) and orientation (mᵢ) of the magnet. Instead, an exemplary embodiment uses a kinematic model of the hand. By using a kinematic model, extra constraints the human finger imposes on the possible position and orientation of the magnet placed on the fingertip may advantageously be taken into account. The particle filter then models the angles of the kinematic model and given those angles can directly compute the given position and orientation of the fingertip (and therefore the magnet).

In an exemplary embodiment, a kinematic model has five angles, two degrees of freedom at the metacar-pophalangeal joint (MCP) at the base of the finger, one degree of freedom each at the proximal interphalangeal (PIP) and distal interphalangeal (DIP) joints, and one degree of freedom to account for possible misplacement of the magnet on the fingertip. In particular, an angle associated with this latter degree of freedom accounts for a small (fixed) rotation where the magnet is a bit off to the side of the finger instead of directly on the back of the fingernail. In addition, the lengths of the bones in the finger and placement of the sensor and magnet are assumed to be in known locations. In a variant of the described exemplary embodiment, it would be possible to model these variables as well. In accordance with another aspect, a motion model for the particle filter describes how the particle state (and associated finger/magnet movement) advances from one time to the next. An exemplary embodiment uses the kinematic model and assumes each joint can move independently by a small rotation at each time step.

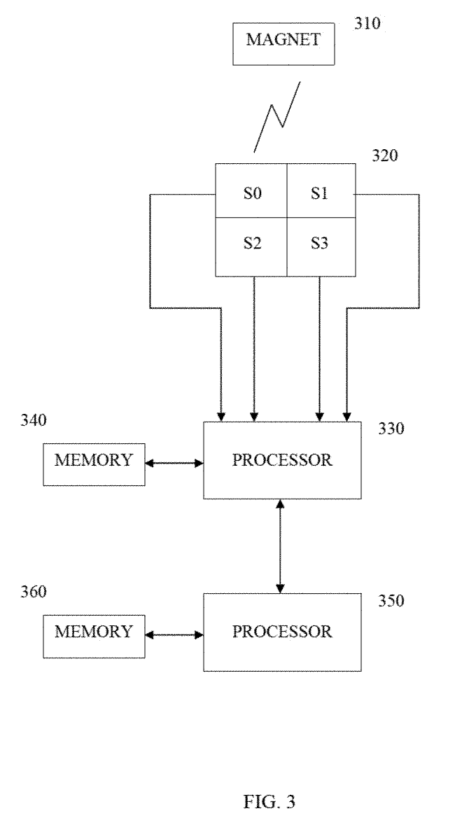

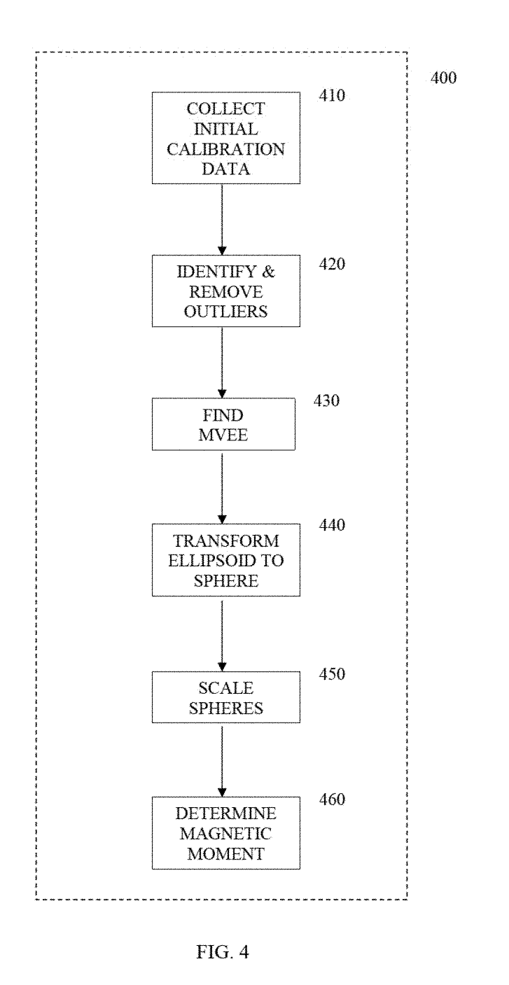

An exemplary embodiment of apparatus in accordance with the present principles is illustrated in FIG. 3. In FIG. 3, a permanent magnet 310 produces a magnetic field sensed by a sensor array 320. The sensor array may include four sensors S0, S1, S2, and S3. Although four sensors are illustrated in FIG. 3, in accordance with the present principles the number of sensors included in the array may be more or less than four. An exemplary embodiment of the sensor array may be created using four Honeywell HMC5883L 3-axis magnetometers. Magnet 310 and sensor array 320 may be placed on a hand of a user such as in the exemplary arrangement illustrated in FIG. 1 where the magnet is mounted on a fingertip (e.g., fingernail) and the sensor array is placed on the back of the hand. An exemplary arrangement of four sensors to produce sensor array 320 comprises arranging the sensors in a 2×2 grid to a 3D printed structure so that they are all aligned and fixed with a known distance between the sensors (e.g., 2.1 cm and 1.8 cm separation in the X and Y axes, respectively). The sensors may be connected, e.g., via an I2C bus, to a first processor 330, e.g., a microcontroller, that is located in proximity to the sensors (e.g., on the hand). The first processor may be coupled to a memory such as memory 340 shown in FIG. 4 for storing sensor data and or software ware program code executable by processor 330. The connection between the sensors and the first processor may be, in parallel, e.g., on four different channels as illustrated in FIG. 3. The processor streams data over a second connection, e.g., USB serial connection to a second processor 350 that may be remote, e.g., a laptop computer such as a MacBook Air. Second processor 350 may be coupled to memory such as memory 360 for storing data received from processor 330 and/or software program code executable by second processor 350. As will be readily apparent to one skilled in the art, connections described as wired may alternatively be created using wireless means either alone or in combination with wired connections. The second and/or first processors may perform processing in accordance with the present principles by executing software stored in memory such as memory 340 and/or 360. The software may be created using one or more of various programming languages such as Python and Numba.

One or more processors, such as a GPU, may be used locally and/or remotely from the sensors to accelerate vector operations included in processing in accordance with the present principles. For the kinematic model in an exemplary embodiment, the length of each of the phalanges as well as the placement of the sensor and magnet are measured and input as fixed parameters to the software. In accordance with another aspect, an exemplary embodiment uses 250 particles.

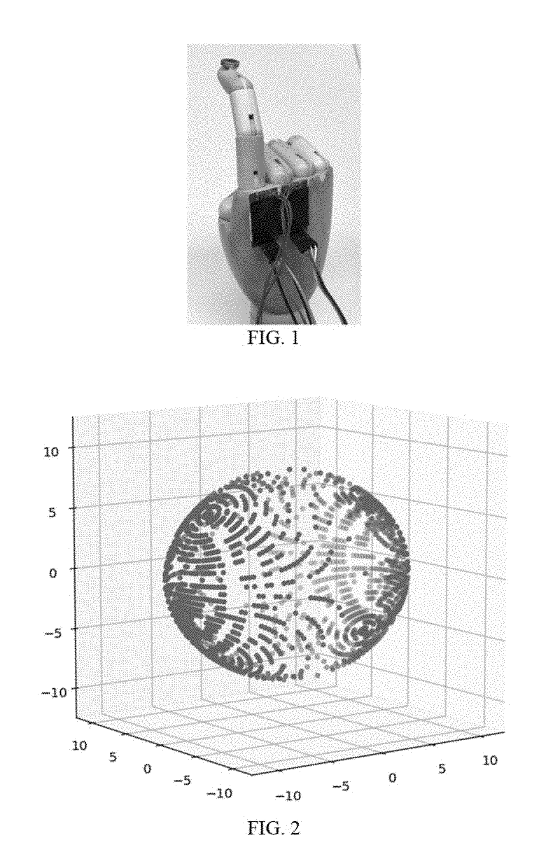

An exemplary embodiment using multiple magnetometers and computing the magnetic field may also calibrate the sensors for both hard and soft iron effects. FIG. 4 illustrates an exemplary embodiment of a method of calibration 400. In FIG. 4, calibration begins by collecting initial calibration data at step 410 whereby the sensors are rotated through various different angles. If the sensors are perfectly calibrated, the resulting data will fit on a surface of a sphere such as that illustrated in FIG. 2 with a radius being the magnitude of the ambient magnetic field. In practice, the sphere is not centered due to hard iron effects and can be deformed into an ellipsoid due to soft iron effects. Furthermore, distortions for each sensor may differ. At step 420, the magnitude of each reading for a given sensor is considered and any points more than two standard deviations from the mean magnitude (referred to herein as “outliers”) are removed. Then, at step 430, the Minimum Volume Enclosing Ellipsoid (MVEE) for each sensor may be found using, for example, the Khachiyan Algorithm. For the calibration data, these parameters enable transforming a raw magnetometer reading (on the ellipsoid) to a corresponding calibrated reading (on the sphere) at step 440 in FIG. 4. Furthermore, at step 450, a sphere for each sensor may be scaled to the same value since during calibration the sensors are reading the same ambient field. When the system is in use, this same transform may be used to correct the raw sensor readings. Another aspect of calibration involves determining the magnetic moment (M) of the permanent magnet used at step 460. Using the calibrated sensor data, the magnet may be placed at a known location and orientation with respect to the sensor. For a given magnetic field reading, we can then calculate M from Equation 1. Data may be collected at a few different locations and the mean value of M may then be used for an embodiment.

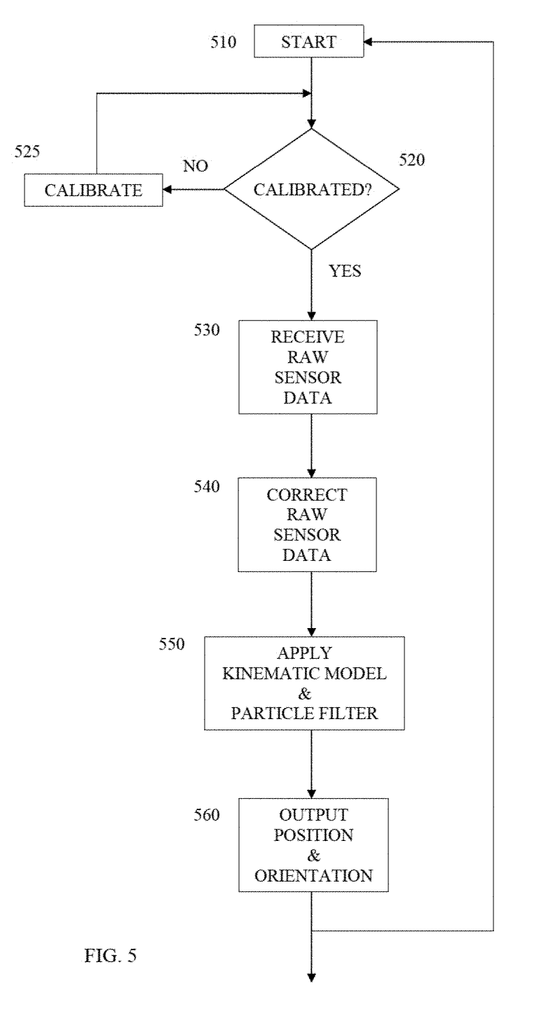

FIG. 5 illustrates a method of determining position and orientation using magnetic fields in accordance with the present principles. Following the start of the method of FIG. 5 at step 510, step 520 checks to determine if the sensor array, e.g., sensor array 320 in FIG. 3, has been calibrated. If not, step 520 is followed by step 525 performs sensor calibration, e.g., using calibration method 400 shown in FIG. 4. If calibration is complete, then step 520 is followed by step 530 where “raw” (i.e., unprocessed) sensor data produced by a sensor array such as sensor array 320 in FIG. 3 is received, e.g., by a processor such as processor 330 in FIG. 3. The raw sensor data is corrected at step 540, e.g., by applying a transform such as that created during calibration and applied, e.g., at step 440 in FIG. 4. Step 540 is followed by step 550 where a kinematic model and particle filter are applied to the corrected data as explained above. Following the processing at step 550, values of parameters such as position and orientation values are output at step 560. The method illustrated in FIG. 5 may then repeat to produce additional position and orientation values. Thus, the present principles may be applied as described herein to applications such as determining a motion and orientation of a hand of a user, thereby enabling a user to provide input for control of auditor interaction with a device or environment such as a virtual reality environment. As a more specific example, parameters determined by a magnetic field sensing system in accordance with the present principles may be used, for example, as inputs to a user interface system to indicate gestures, direction of pointing, etc. of a user's hand. Such information may be used via the user interface system to control various devices such as computer systems, computer-aided design (CAD) systems, home entertainment or gaming systems, virtual or augmented reality systems etc. A magnetic field system in accordance with the present disclosure may facilitate and improve the operation of such a user interface system, e.g., by improving the accuracy of recognition of a user's commands.

It is to be appreciated that the various features shown and described are interchangeable, that is a feature shown in one embodiment may be incorporated into another embodiment. Although embodiments which incorporate the teachings of the present disclosure have been shown and described in detail herein, those skilled in the art can readily devise many other varied embodiments, modifications and variations that still incorporate these teachings.

It should be understood that the elements shown in the figures may be implemented in various forms of hardware, software or combinations thereof including, but not limited to, for example one or more appropriately programmed general-purpose devices, which may include a processor, memory and input/output interfaces. Herein, the phrase “coupled” is defined to mean directly connected to or indirectly connected with or through one or more intermediate components, wherein connections may be wired or wireless. Such intermediate components may include both hardware and software based components.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read only memory (ROM) for storing software, random access memory (RAM), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means the scope of the disclosure as outlined by the appended claims.

1. A method comprising:
receiving a plurality of signals from each of a respective one of a plurality of magnetic field sensors in an array of sensors located in proximity to a magnet mounted on an object, wherein each sensor in the array has a fixed position with respect to other sensors in the array and each of the plurality of signals represents a magnetic field Value at the respective sensor;
processing the plurality of signals to provide a plurality of respective corrected signals including a correction for an ambient magnetic field component and for non-ideal characteristics of the sensors; and
processing the plurality of corrected signals to determine a parameter associated with an input from a user.

2. The method of claim 1 wherein the processing of the plurality of signals comprises using pairs of signals included in the plurality of signals from the plurality of sensors to determine two difference readings to cancel out the ambient magnetic field in the plurality of corrected signals.

3. The method of claim 1 wherein the processing of the plurality of corrected signals comprises creating a motion model of the object using a kinematic model of a motion of the object.

4. The method of claim 1 wherein the processing of the plurality of corrected signals comprises using a particle filter and a motion model to determine the parameter.

5. The method of claim 1 further comprising calibrating the plurality of sensors prior to processing the plurality of signals.

6. The method of claim 5 wherein calibrating comprises determining a minimum volume enclosing ellipsoid (MVEE) for each sensor.

7. The method of claim 6 wherein calibrating further comprises determining a transform for each sensor to transform the ellipsoid associated with the MVEE for the sensor to a sphere.

8. The method of claim 7 wherein calibrating further comprises scaling the sphere associated with each sensor.

9. The method of claim 8 wherein calibrating further comprises processing the data associated with the scaled sphere for each sensor to determine a magnetic moment.

10. Apparatus comprising at least one processor configured to:
receive a plurality of signals from each of a respective one of a plurality of magnetic field sensors in an array of sensors located in proximity to a magnet mounted on an object, wherein each sensor in the may has a fixed position with respect to other sensors in the array and each of the plurality of signals represents a magnetic field value at the respective sensor;
process the plurality of signals to provide a plurality of respective corrected signals including a correction for an ambient magnetic field component and for non-ideal characteristics of the sensors; and
process the plurality of corrected signals to determine a parameter associated with an input from a user.

11. The apparatus of claim 10 wherein the processor is further configured to process the plurality of signals using pairs of signals included in the plurality of signals from the plurality of sensors to determine two difference readings to cancel out the ambient magnetic field in the plurality of corrected signals.

12. The apparatus of claim 10 wherein the processor is further configured to process the plurality of corrected signals to create a motion model of the object using a kinematic model of a motion of the object.

13. The apparatus of claim 10 wherein the processor is further configured to process the plurality of corrected signals using a particle filter and a motion model to determine the parameter.

14. The apparatus of claim 10 wherein the processor is farther configured to calibrate the plurality of sensors prior to processing the plurality of signals.

15. The apparatus of claim 14 wherein calibrating by the processor comprises the processor determining a minimum volume enclosing ellipsoid (MVEE) for each sensor.

16. The apparatus of claim 15 wherein calibrating by the processor further comprises determining a transform for each sensor to transform the ellipsoid associated with the MVEE for the sensor to a sphere.

17. The apparatus of claim 16 wherein calibrating by the processor further comprises scaling the sphere associated with each sensor.

18. The apparatus of claim 17 wherein calibrating by the processor further comprises processing the data associated with the scaled sphere for each sensor to determine a magnetic moment.

19. A system comprising:
a magnet configured for mounting on an object;
a plurality of magnetic field sensors forming an array of sensors located in proximity to the magnet, wherein each sensor in the array has a fixed position with respect to other sensors in the array and each sensor produces a signal representing a magnetic field value at the sensor; and
a processor processing the plurality of signals produced by the array of sensors to provide a respective plurality of corrected signals including a correction for an ambient magnetic field component and for a non-ideal characteristic of the sensors, and processing the plurality of corrected signals to determine a parameter associated with an input from a user.

20. A non-transitory computer-readable medium storing computer-executable instructions executable to perform a method according to claim 1.
